(19) United States
(12) Patent Application Publication
(10) Pub. No.: US 2002/0104255 A1
(43) Pub. Date: Aug. 8, 2002

(54) Trap for crawling insects

(76) Inventor: Graham Hobson, Brighton (GB)

Correspondence Address: ALIX YALE & RISTAS LLP, 750 MAIN STREET, SUITE 1400, HARTFORD, CT, 06103, US

(21) Appl. No.: 09/550,002

(22) Filed: Apr. 14, 2000

(30) Foreign Application Priority Data
Apr. 14, 1999 (GB) 9908522.7

(51) Int. Cl. A01M 1/14

(52) U.S. Cl. 43/114

(57) ABSTRACT

The present invention relates to a trap for crawling insects, particularly cockroaches, being in form of a box or a raised surface which is accessed by the insects via ramps beginning inwardly of the periphery of the base and beneath the base.

The present invention relates to a trap for crawling insects particularly, but not exclusively, for catching cockroaches.

Crawling insects, particularly cockroaches, are a major pest problem in many parts of the world and in many domestic, commercial and industrial environments. Cockroaches are a particular problem on ships but, of course, the problems caused by crawling insects are experienced in many areas of life.

Many different methods and devices have been used to attempt to control insects. Pest control methods use both chemical or insecticide approaches and, where chemicals are not appropriate, trapping methods and devices are used.

Great advances have been made in chemical control, including the use of contact insecticides and bait stations and Insect Growth Regulators (IGRs) which have a longer term, preventative effect in that they can make future generations of cockroaches sterile. Biological control methods will also shortly be licensed with the use of either bacteria or fungal control methods which literally eat the insect from the inside.

Although the use of chemical control is important and has proved to be very effective, there are many situations where the use of chemicals is not permitted or is not appropriate. These days, there is more and more emphasis on avoiding the use of chemicals and in these cases, the simple insect trap has proved an effective and important alternative. Also, irrespective of whether a premises has an infestation, it is important that crawling insect traps are used to demonstrate to both Port Health (ship based) and Environmental Health (land based) Officers that control of infestation is being monitored and maintained.

A wide variety of different traps is available and many others have been tried. A preferred, very simple trap for crawling insects is a simple cardboard trap for example the “LO-LINE” cockroach trap. This trap is provided in the form of a cardboard blank which is folded into a trapezoidal box inside of which is a sticky surface with a silicon release paper to protect the surface until ready for use, when the paper is removed and thrown away. A scented tablet, attractive to cockroaches, etc., may be placed in the middle of the sticky surface to enhance the attractiveness of the trap to the target insect. The ends of the box are open and short ramps are formed extending upwards and inwards from the ends of the base. The cockroach, attracted to the trap, for example by the scented tablet, will climb the small ramp and jump or fall down onto the sticky surface on the base where it will be trapped. As more cockroaches are attracted to the trap, the sticky surface of the base will fill with insects until the base is full. Such traps, in ideal conditions, will normally last around one month and can then be simply thrown away and replaced with a new trap.

The advantages of such traps is that they are very simple and inexpensive and are easily disposable. The traps have proved, in most conditions, to be effective and efficient and are widely used in commercial, industrial and domestic premises throughout the world.

There are, however, a number of disadvantages associated with these simple disposable traps.

The traps, as discussed above, are made of cardboard and are simply folded into shape and placed usually on the floor of the building or location where the insect problem exists. One problem is that cockroaches, and other pests, are often found in wet, damp and humid areas and the simple cardboard traps soon become water-logged. When the glue forming the sticky surface becomes wet, its insect holding properties deteriorate and the trap becomes generally ineffective. When a cardboard trap becomes wet, it also becomes misshapen and is no longer suitable for its purpose.

Another problem is that, as the ends and sides of the trap are open, to enable the insects to enter the trap, if there is dust in the environment, the sticky surface quickly becomes non-tacky due to a build-up of dust. Again, when this happens, the effectiveness of the trap becomes severely limited and, eventually, the trap becomes useless.

Another problem is that as the traps are made of cardboard, they are not particularly robust and are easily crushed.

All of these problems are particularly acute when used on ships where the cockroach problem is often severe. Of course, the problem also arises in many other environments.

As the cardboard traps are light and are merely placed on the floor, they can be easily removed and it has been found that in countries where there is a domestic cockroach problem, traps are sometimes stolen from ships, commercial or industrial properties or traps are easily moved away from the site of the problem, perhaps to a crew member's cabin if they have a cabin infestation.

It is the object of the present invention to provide a cockroach trap which has enhanced effectiveness in trapping insects in a wider range of conditions. The preferred form of the present invention overcomes all of the problems discussed above, in relation to the existing traps, as well as offering what appears to be a safe and dark harbourage.

The present invention provides a trap for crawling insects, comprising:

a raised base, and

one or more ramps providing access to the surface of the base from beneath the base, the ramp or ramps extending upwards and outwards from a point beneath the base and inwards of its periphery.

In a preferred embodiment, the trap is in the form of an enclosed box having a lid and a base, wherein access to the interior of the box for the insects is provided by the ramps.

Preferably, the trap is in the form of a secure box, lockable to prevent unauthorised access, but having an entrance into the box for insects, and wherein the box is adapted to contain an insect control substance (e.g. a gel or bait). Being offered in an enclosed area will help improve bait take.

The upper surface of the base is preferably arranged to receive or be provided with a sticky surface. Whilst the sticky surface may be provided directly onto the base, if a cardboard insert provided with a sticky insert is used, only the insert needs to be replaced when full or no longer sticky, making the trap reusable and also allowing the trap to be cleaned.

The raised base is preferably formed by placing a separate flat plate onto the top of the ramps although the base and the ramps can be formed integrally.

The ramps are preferably provided with ‘wings’ in the form of metal extensions protruding beyond the ramp openings at the sides to prevent water getting into the trap even when water is sprayed directly at the trap.

The trap is preferably in the form of a box having a main body from which the ramps extend inwardly, a removable base locatable in the main body of the box so as to be accessible via the ramps and preferably a lid.

For added security, the lid is preferably lockable e.g. by means of a captive bolt locking arrangement. Of course security is improved over the prior art by the use of any other locking arrangement.

Although the trap has advantages over the prior art because of the configuration of its ramps, and so will be an improved trap whatever material it is made of, the trap is sturdier and longer lasting if made of metal e.g. food grade stainless steel.

The trap may also be provided with means for locking it in the position in which it is placed. The locked lid will help prevent unauthorised removal as the locking nuts etc. will be on the inside of the trap, under the removable base.

The main feature of the present invention is that the ramps are internal ramps, i.e. rather than, as in conventional designs, the slopes extending from floor level at the outside of the trap body, upwards and inwards, the ramps begin beneath the base of the trap and extend upwards and outwards to the outer side of the trap body. This essentially overcomes the problem of water getting into the sticky part of the trap. Instead, the inner ramps, which can be at any angle to the ground, deflect any water towards the ground.

In the preferred embodiment, the trap is provided with wings which help to prevent any water from going around the side of the ramp and up into the trap floor where the sticky insert is provided.

This preferred design of the present trap results in the trap being resistant to water both dropped and sprayed at it. Tests have shown that the preferred design will keep out up to 95% of the water away from the sticky insert, thus maintaining the efficacy of the trap for longer.

Further, the raised base design of the present invention allows the trap to be placed on a surface which gets wet, without this affecting the efficacy of the trap. The preferred arrangement allows for a water level of approximately 5 mm across the floor, without the sticky insert becoming wet.

In the preferred embodiment, the entire trap is made from stainless steel. This provides a particularly crush resistant trap, under normal use. Tests have shown that the trap can even withstand the weight of a man, without the cardboard insert becoming crushed. of course, the trap may be made of other materials, for example plastic or other metals or even laminated cardboard. Some advantages will be obtained over existing cardboard traps even using the same material to make a trap of the inventive design. Of course, the resistance to crushing will be less for a cardboard trap.

For metal and plastic traps, another advantage is that the traps can be reusable and washable and only the sticky insert need be replaced. It is preferred (but not essential) that the trap will be adapted to receive any of the readily available sticky inserts including those known as “Trapper”, “Biological Control Systems”, “Lo-Line” and “Hoy Hoy”. Alternatively, proprietary sized inserts could be made available and used. In the preferred embodiment, where the trap is enclosed, the effectiveness of the trap will be essentially unaffected by the dusty environment or by other airborne debris or pollutants, as the sticky insert will be protected against such pollutants.

Another disadvantage of the existing cardboard traps is that the trap is essentially open at all times to any light within the premises. In its preferred embodiment, the present invention encloses the sticky insert and trap providing a dark protected harbour for cockroaches into which they are encouraged to enter and remain. This enhances the efficacy of the trap by increasing the chance that the cockroaches, etc., will be stuck to the sticky insert. They are also encouraged to remain and feed if a cockroach gel/bait is utilised within the box.

The box is preferably lockable and preferably uses a “captive” bolt using a standard Phillips or flatheaded screw. If added security is required, a special security screw may be used. By utilizing a “captive” bolt, there is no chance of the screw becoming lost and/or dropping into products, food, etc., in processing plants. Furthermore, a locked, contained box prevents the size of the insect problem being disclosed and allows access to authorised personnel only for monitoring purposes.

The trap is preferably adapted to be secured to the floor and, for additional security, the securing means may be located inside the trap so that the trap can only be removed if the locked lid is open.

For convenience and ease of manufacture, as well as to be suitable to receive standard sticky inserts, the trap is preferably rectangular in shape. However, the concept of the invention can also be used in any other shaped trap including triangular, square, 5, 6, 7 or more sided shapes, dome shaped or convex shaped traps. With dome or convex shaped traps, water-shedding/repellency is further enhanced.

Preferably, the trap base is removably arranged in the trap housing for ease of cleaning and for securing the trap.

The trap of the present invention is particularly environmentally friendly in that it does not use any active chemicals, just bait, food or a scented tablet or lure together with a sticky cardboard insert.

The preferred embodiment of the trap of the present invention will now be described in detail, with reference to the accompanying drawings.

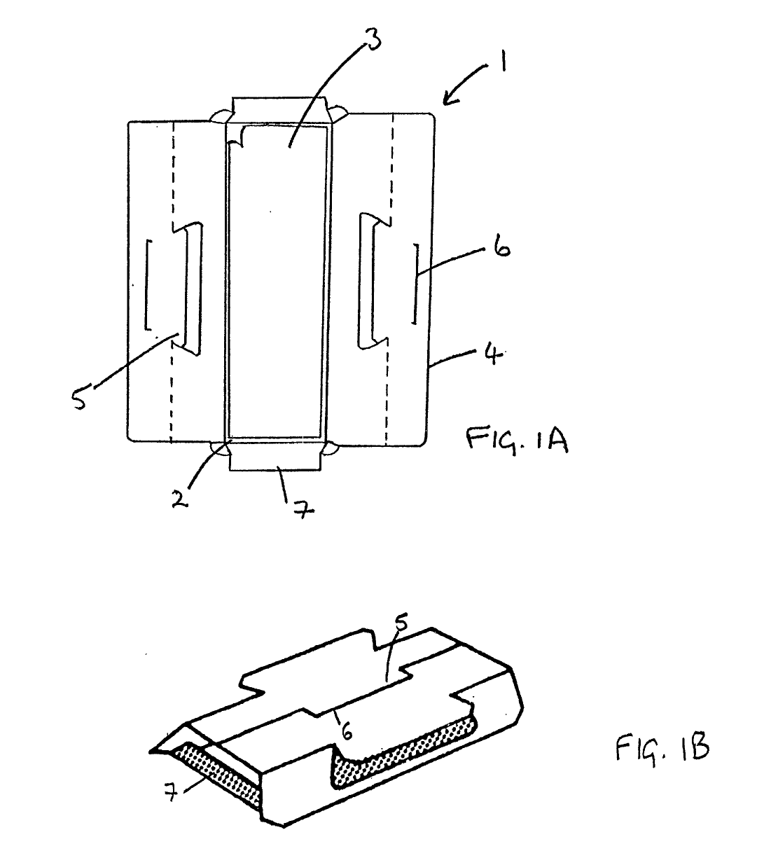

FIG. 1 shows an existing cardboard trap such as the “Lo-Line” cockroach trap; FIG. 1A shows the blank and FIG. 1B shows the made up trap;

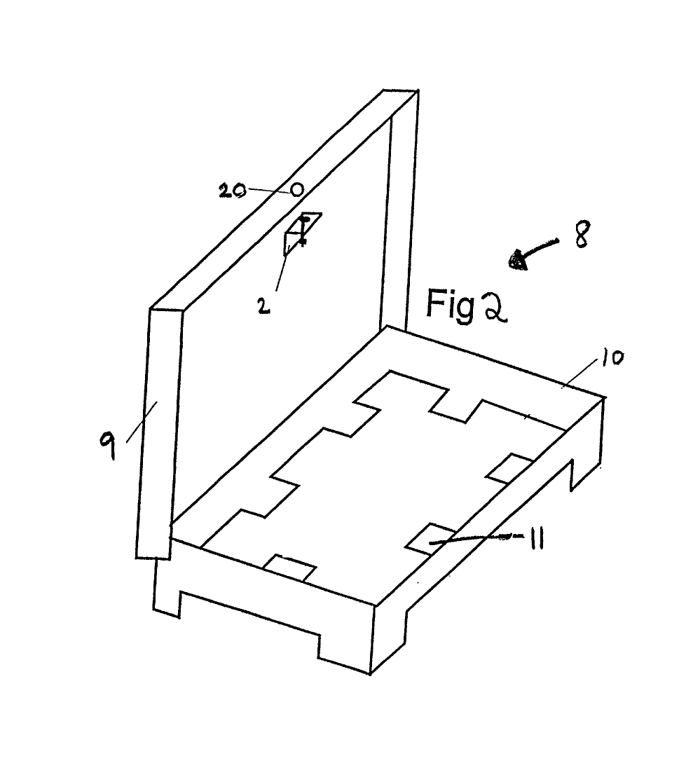

FIG. 2 is a perspective view of a preferred embodiment of the present invention, with the lid open;

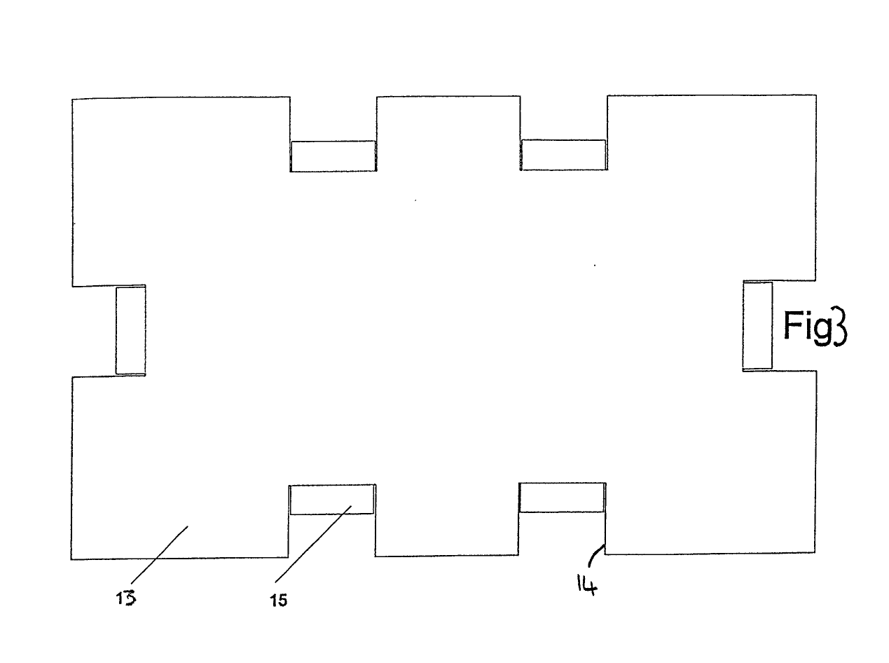

FIG. 3 is a top view of the base and ramps of the preferred embodiment of the present invention;

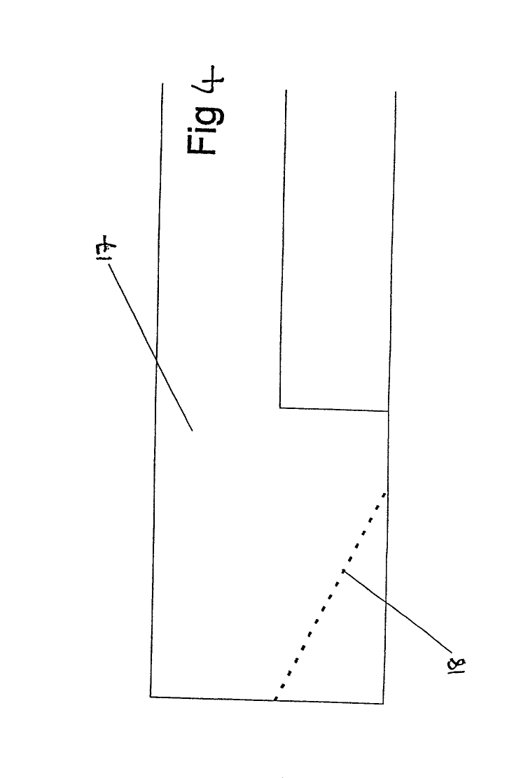

FIG. 4 is a side view of a preferred embodiment of the present invention;

FIG. 5 shows one side of the box of the preferred embodiment prior to assembly; and

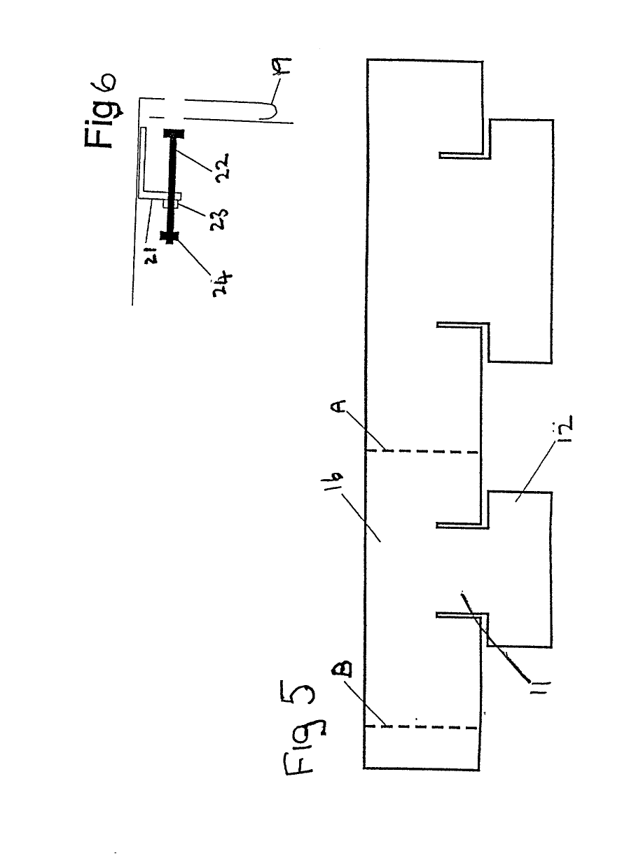

FIG. 6 shows a preferred locking arrangement for an embodiment of the present invention.

First, with reference to FIG. 1, the prior art trap will be briefly described.

The trap is supplied in the form of a cardboard blank 1. The blank comprises a central portion 2, which forms the base of the trap when assembled. The central portion is provided with a sticky surface covered by a protective paper 3. The blank also has two side portions 4 provided with matching tabs 5 and slots 6. At the short ends of the central portion are provided end flaps 7.

To assemble the trap, the protective paper 3 is first peeled off to reveal the sticky surface. A lure tablet or other bait may be placed in the centre of the sticky base. The side portions are then folded upwards and connected by the interlocking tabs and slots to form a tent-like trap.

The end flaps 7 are then folded inwards at an angle of 45 degrees to form ramps. The trap is then placed in a suitable location and can be disposed of when the sticky base is full of insects or is no longer sticky.

The insects are attracted by the lure and climb up the ramps formed by the end flaps, or flap holes at the side of the trap. At the top of the ramp the insects drop into the trap and are caught by the sticky base.

As discussed above, although these traps have proved effective and easy to use, they do have a number of disadvantages, particularly in wet or dirty environments.

The aim of the present invention is to provide a trap which overcomes these problems.

A preferred embodiment of the trap of the present invention will now be described with reference to FIGS. 2-6.

Referring first to FIG. 2, the preferred arrangement of the present trap 8 comprises a rectangular, stainless steel box with a close-fitting hinged or pivotally attached lid 9. The lid is arranged such that when it is in the closed position, its edges fit over the outside of the main body 10 of the box. This provides a hood type cover which reduces the risk of water getting into the trap.

Ramps 11 are formed along the sides of the main body 10 of the box. The ramps are formed by making cuts in the walls of the box, extending from the bottom, part way up each side to form flaps. The flaps are then bent inwards forming ramps extending upwardly and outwardly from the interior of the box, ending at the interior of the side walls of the box.

The ramps are formed with wings 12 that are extensions of the side ramp 11 to provide better protection against water sprayed at or near the trap.

An insert plate 13 is formed so as to be located within the main body of the box and to rest on the tops of the ramps.

As shown in FIG. 3, the insert has cut-out sections 14 around its periphery to provide entry points from the ramps to the surface of the insert 13.

The corners or other parts 15 of the insert may be provided with upstanding tabs or lips to enable a sticky sheet or insert (not shown) to be easily and squarely located on the insert.

When assembled, looked at from the top, when the box is open, there is presented a flat surface 13, on which is placed a sticky insert such as used in previous traps, with a number of entry openings 14 around its circumference. The ramps 11 begin beneath the insert, inwards of its edges, and end at the outer edges of the insert allowing access via the ramps through the entry openings to the sticky surface.

The main body 10 of the box may be formed from two strips of sheet metal as shown in FIG. 5. The metal sheet 16 is formed with a number of fold points and has the ramp portions 11 and wings 12 formed integrally with the strip by cutting or die pressing.

The metal strip is formed into an L-shape by folding at fold line A. The ramp portions 11 are then bent inwards. A 90 degree fold is also made at fold line B to form a tab. A similar section is formed from a second strip of metal, similarly formed. The two essentially L-shaped strips are then attached together by welding at the small tab portions formed by the folds B. This forms the essentially rectangular box to which the lid is then attached.

FIG. 4 shows a view from the front 17 of the box showing, by dotted lines 18, the angle of the ramps. This angle can, of course, be varied and the ramps lengthened or shortened by varying the height in FIG. 5 of the preformed side.

To avoid rough edges, the lid is formed with a rolled front edge 19 which fits over the front edge of the body of the box. This allows a depth for the securing captive bolt mechanism as in FIG. 6.

The front edge of the lid is provided with a hole 20 in the middle. A corresponding hole (not shown) is formed in the front edge of the body of the box. In the preferred arrangement, the box is provided with a captive bolt locking arrangement as shown in detail in FIG. 6.

An angled bracket 21 is spot welded to the lid. This receives a stainless steel flat headed, Phillips cross-headed or security screw 22. The screw is held in the bracket by means of a threaded bush 23 which is welded to the angled bracket. A Nylock nut 24 or double nut is provided at the end of the security screw 22 to prevent the screw from being removed or lost whilst locking.

Angled brackets (not shown) may also be provided at the corners of the main body of the box, to enable the trap to be secured by bolting to the ground etc. The screws used for securing the box to the floor are preferably accessible only from the inside of the box so that when the box is locked it cannot be removed by unauthorised personnel.

The present invention thus provides an insect trap which is sturdy and effective and secure and which avoids the problems of previous traps when used in wet, dusty or dirty environments.

1. A trap for crawling insects, comprising:
a raised base, and
one or more ramps providing access to the surface of the base from beneath the base, the ramp or ramps extending upwards and outwards from a point beneath the base and inwards of its periphery.

2. A trap as claimed in claim 1 in the form of an enclosed box having a lid and containing said base, wherein access to the interior of the box for the insects is provided by said ramp or ramps.

3. A trap as claimed in claim 1 or 2, wherein the base has an upper surface arranged to receive or provided with a sticky surface.

4. A trap as claimed in claim 3 wherein the sticky surface is in the form of a removable insert provided with a sticky surface.

5. A trap as claimed in any preceding claim, having a raised base comprising a removable flat plate locatable on the top of the ramps.

6. A trap as claimed in any preceding claim, wherein the ramps are provided with extensions which protrude beyond the ramp openings at the sides.

7. A trap as claimed in any preceding claim in the form of a box having a main body from which the ramps extend inwardly, a removable base locatable in the main body of the box so as to be accessible via the ramps, and a lid.

8. A trap as claimed in claim 7, wherein the lid is lockable.

9. A trap as claimed in any preceding claim formed of metal.

10. A trap as claimed in any preceding claim, further provided with means for securing the trap to the floor or surface on which the trap is placed.

11. A trap as claimed in any preceding claim in the form of a secure box, lockable to prevent unauthorised access, and wherein the box is adapted to contain an insect control substance.
